(19) United States
(12) Patent Application Publication
(10) Pub. No.: US 2014/0011409 A1
(43) Pub. Date: Jan. 9, 2014

(54) ELECTRICALLY CONDUCTIVE SCREW CONNECTION AND SPECIAL BUSHING FOR A SCREW CONNECTION OF SAID TYPE

(71) Applicants: Thorsten Schraer, Gerolsbach (DE); Wolfgang Giraud, Nurnberg (DE)

(72) Inventors: Thorsten Schraer, Gerolsbach (DE); Wolfgang Giraud, Nurnberg (DE)

(73) Assignee: RUIA GLOBAL FASTENERS AG, Neuss (DE)

(21) Appl. No.: 14/005,897

(22) PCT Filed: Mar. 26, 2012
(86) PCT No.: PCT/DE2012/000017

§ 371 Date: Sep. 18, 2013

(30) Foreign Application Priority Data
May 20, 2011 (DE) 10 2011 102 680.4

(51) Int. Cl. H01R 4/30

(52) U.S. Cl. CPC H01R 4/307
USPC 439/784

(57) ABSTRACT

An electrically conductive screw connection between two parts (10, 12) which are screwed to one another by means of a screw (16) with a screw head (18) and with a shank (22) with an external thread (24) and by means of a nut (28), wherein the screw (16) runs through a bore (14) in one part (10), wherein the electrical contact between the other part (12) and the screw (16) is produced by teeth (27) on the workpiece-side surface of the screw head (18) and/or of the nut (28) or of a washer (30) arranged between the nut (28) and the other part (12), whereas the contact between the screw (16) and one part (10) is produced by a bushing (34; 34′) which is formed so as to be radially elastic and which is arranged coaxially with respect to the shank (22) of the screw (16) in a portion (15) of the bore (14) with an enlarged inner diameter.

### TECHNICAL FIELD

The present invention relates to an electrically conductive screw connection between two parts which are screwed to one another by means of a screw having a screw head and a shank, wherein the screw runs through a bore in one part. The present invention also relates to a special bushing for screw connections of this type.

### PRIOR ART

Since modern motor vehicles are increasingly equipped with highly sensitive electronics, it is necessary for all electrically conductive parts, i.e. substantially all metal parts of a motor vehicle, to be connected to earth so as to be electrically conductive with low resistance.

In the past, additional large earth cables or other devices were provided for this purpose. This always led to the need to install additional parts, which involved additional costs and additional weight, wherein these parts often did not fulfil their function satisfactorily, since frequently the contact was too poor, or deteriorated over time due to corrosion and electrochemical effects. For example, nowadays for a steering gear made of aluminium the automobile industry requires an earth contact with two cables each having a diameter of ten millimetres.

A direct contact between the individual components of a vehicle is no longer offered automatically nowadays, since for corrosion resistance the parts are generally already coated and/or varnished before the final installation, and because aluminium parts form an insulating passivation layer of aluminium oxide by themselves.

Furthermore an electrically conductive screw connection for this purpose is already known from German Utility Model 20 2010 007 769 U1 of the Applicant, in which the low-resistance electrical contact between a part and the screw is produced by teeth on the workpiece-side surface of the screw head and/or of the nut or of a washer arranged between the nut and the one part, whereas the contact between the screw and the further part is produced by raised portions on the shank of the screw, the external diameter of which is slightly larger is than the internal diameter of the bore into which the screw is inserted, wherein these raised portions are arranged between the external thread and the screw head.

This solution has proved reliable in principle, but it has been shown that when a screw of this type is replaced during servicing, contact problems can occur due to manufacturing tolerances. Therefore an object of the present invention is to provide an electrically conductive screw connection of this type which, even after being dismantled and assembled a number of times and even after replacement of the originally machined screw by a new one, is capable of producing an equally good, extremely low-resistance contact between the screwed components. Moreover, an object of the present invention is to make available a low-resistance earth connection of this type which is structurally simpler to produce.

### SUMMARY OF THE INVENTION

According to the invention, this object is achieved by an electrically conductive screw connection in which a low-resistance electrical contact is produced between one of the parts and the screw by teeth on the workpiece-side surface of the screw head or of a washer arranged between the screw head and the one part, whereas the contact between the screw and the other part is produced by a bushing which is formed so as to be radially elastic and which is arranged coaxially with respect to the shank of the screw in a portion of the bore having an enlarged internal diameter.

Likewise the present object can be achieved by a special bushing into which a screw can be inserted and which can be inserted into in a correspondingly widened hole or into a correspondingly widened portion of a screw hole, and which is formed from a corrugated sheet metal strip, of which the corrugations are arranged parallel to the axis of rotation of the bushing.

In this case it is particularly preferred if three corrugation peaks and three corrugation troughs are arranged over a circumference of the bushing. This is the simplest possible embodiment for the bushing, and enables symmetrical and centred guiding of the screw in the bushing.

Furthermore it is preferable that the sheet metal strip from which the bushing is formed is continuously closed. This increases the stability of the bushing under radial stress. However, a bushing is also possible which is wound and of which the ends butt loosely in front of one another or in which the ends are connected by means of dovetailing or simple guiding.

According to the invention, the corrugation peaks of the bushing can be provided with stamped-out contact claws or with embossed studs or with a cross-knurl or transverse knurl in order to reduce the contact resistance.

For the same purpose, the surfaces of the bushing can be at least partially corrugated or roughened.

Basically the bushing according to the invention can be inserted into an increased diameter of the bore on each end of the workpiece.

However, it is particularly preferred that the portion of the bore having the enlarged internal diameter is arranged on the side of the one part facing the screw head, since then ejection of the bushing from the workpiece during insertion of the screw is prevented.

If the bushing is only to be introduced after the assembly of the parts, then it is preferred to provide the other part with a bore for the screw to pass through, the internal diameter of the bore being greater than the external diameter of the bushing. In this case a solution may then be chosen in which the electrical contact between two parts is produced exclusively by the bushing, the bushing being inserted in the widened bores in both parts, so that a corresponding special screw head or a corresponding special nut or special washer can be completely omitted. By means of its elasticity, the bushing also compensates for slight offsets between the two workpieces.

In the aforementioned solution it is also possible to install the bushing directly under the screw head so as to be rotatable but non-detachable on the shank of the screw. In this way a special operation for installing the bushing is unnecessary and also the bushing does not have to be handled as a separate part. On the other hand, of course a specially manufactured screw is then necessary.

In this solution it is preferable that, for installation of the bushing above the external thread, the shank of the screw is provided with a radial bead, which runs around it and of which the external diameter is less is than the enveloping circle of the bushing.

In order to improve the installation properties of a screw of this type, it is also preferable if the circumferential bead is chamfered towards the external thread of the screw, so that with decreasing height the bead merges into the external thread. Thus the screw centres itself in the enlarged hole portions.

### BRIEF DESCRIPTION OF THE DRAWINGS

The present invention is explained in greater detail below with reference to the embodiment illustrated in the appended drawings. In the drawings:

FIG. 1 shows a screw connection according to the invention with a special screw according to the invention in a sectional representation along the axis of rotation of the screw;

FIG. 2 shows a special screw according to the invention from the front;

FIG. 3 shows a three-dimensional representation of a special bushing according to the invention;

FIG. 4 shows a sectional representation through the special bushing according to the invention fitted onto a screw shank;

FIG. 5 shows the special bushing of the invention according to FIG. 1 from the side; and

FIG. 6 shows a further embodiment of a special bushing according to the invention.

### BEST WAY OF CARRYING OUT THE INVENTION

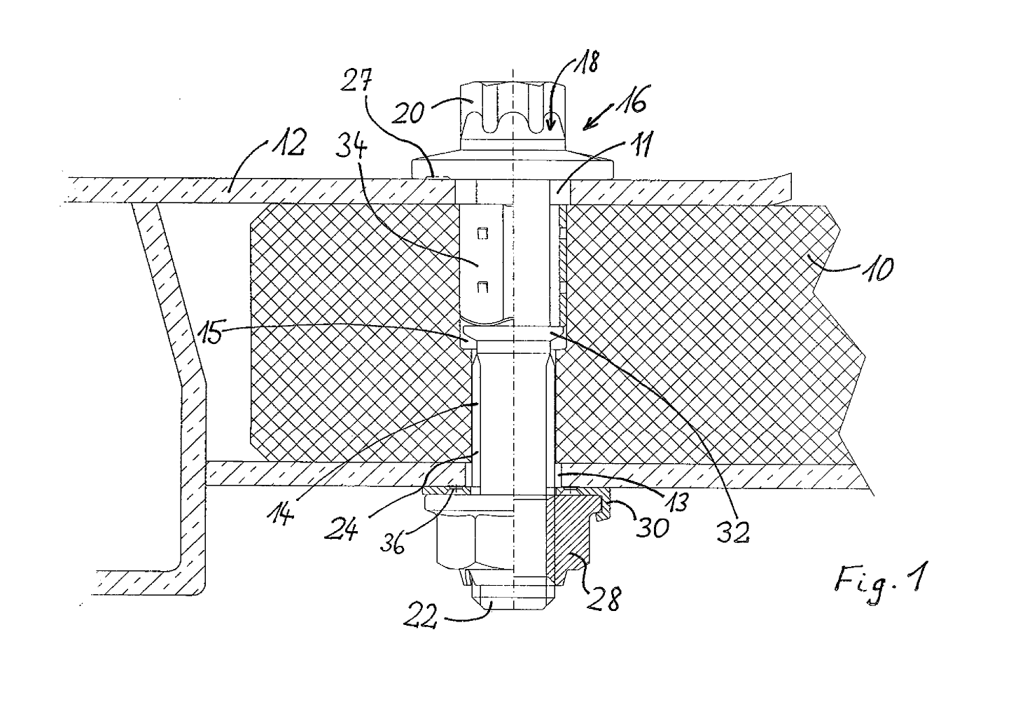

FIG. 1 shows a screw connection according to the invention in a sectional representation along the axis of rotation of the screw.

In the embodiment illustrated here, a part of a steering gear housing made of aluminium as inner part 10 is surrounded by an axle support made of steel as outer part 12; both parts are connected by screwing by means of a screw 16, which extends through a bore 14 in the inner part 10 and two holes 11, 13 in the outer part 12, and a nut 28 having a washer 30. The hole 11 on the screw-head side and a part 15 of the bore 14 on the screw-head side have an enlarged diameter.

In the present case the screw connection according to the invention is constructed so that it simultaneously produces a low-resistance electrical contact between the components 10 and 12, even when they are painted, coated or covered with a passivation layer of aluminium oxide.

In this case the screw 16 has, as is conventional, a screw head 18 having a hexalobular external force application point 20 and a shank 22. As is conventional, the shank 22 of the screw 16 is provided with an external thread 24. However, according to the invention, this external thread 24 does not extend as far as the screw head 18. Instead a circumferential bead 32 is arranged below the screw head 18 and serves to secure a bushing 34 according to the invention below the head 18 of the screw 16. The more detailed construction of the bushing 34 is explained below with reference to FIGS. 3 to 5.

The external diameter of the bead 32 is smaller than the enveloping circle of the bushing 34 and the smallest diameter of the widened portion 15 of the bore 14 and of the hole 11 on the screw-head side.

The diameter of the external enveloping circle of the bushing 34 may be chosen to be somewhat greater than the internal diameter of the widened portion 15 of the bore 14, so that as the bushing is inserted it is slightly compressed radially and thereby a better electrical contact is produced.

The hole 11 in the part 12 can either have a significantly greater internal diameter than the external diameter of the enveloping circle of the bushing 34, in which case the insertion of the screw 16 provided with the bushing 34 is simplified, or a solution is also possible in which the hole 11 has just such a diameter as the widened part 15 of the bore 14. In this case, both the contact with the part 10 and also with the part 12 can be produced by the bushing 34. In such a case, if appropriate, further contacting aids between the screw head 18 and the part 12 and between the nut 28 and/or the washer 30 and the part 12 can be omitted. Such a solution is recommended in particular for cases in which the part 12 is substantially thicker than shown here. Furthermore when used for other purposes and with a substantially thicker part 12, the bushing 34 can be used for producing a contact with the part 12, whereas the screw 16 for example can be screwed into the part 10, so that no separate nut 28 is necessary, and the electrical contact between the screw 16 and the part 10 can be ensured by the screwing of this screw into the part, for example by thread-forming or thread-cutting screws.

Furthermore, with the illustrated combination of components 10 and 12 to be connected, it is possible to use a commercially available screw 16 when the bushing 34 is inserted before installation into the widened portion 15 of the bore 14 of the part 10. Then the screw 16 only has to be pushed through the bushing and the rest of the bore 14 in the part 10 after the part 12 is appropriately positioned. In this case widening of the hole 11 in the part 12 can also be omitted.

In this type of installation, in which the bushing is previously inserted into the part 10, it is also not absolutely necessary to provide the widened portion 15 of the bore 14 on the screw-head side of the part 10. In such a case the widened portion 15 could also be provided on the nut side of the screw connection.

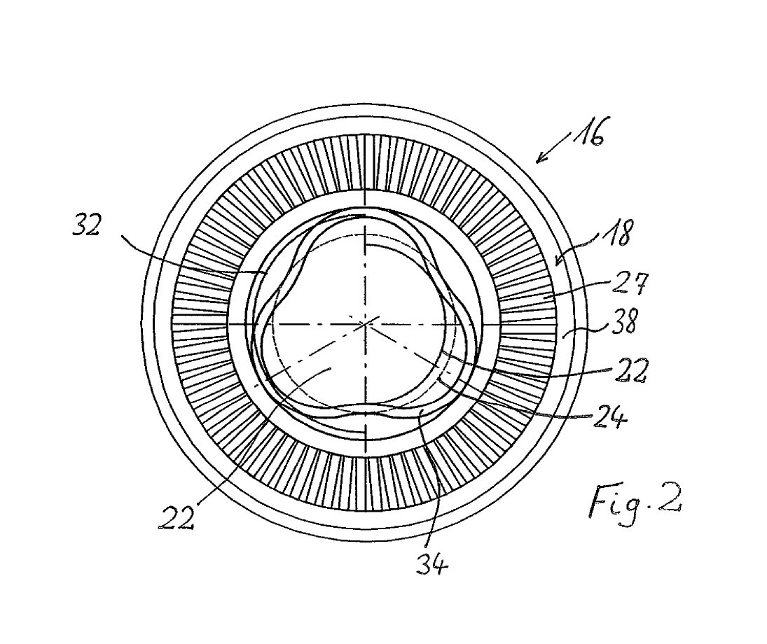

When the external part 12 is painted or coated, for example by cataphoretic painting (cataphoretic immersion painting—CIP), according to the invention a low-resistance contact must then be produced between this external part 12 and the screw 18. According to the invention, this can be effected by teeth 27 which are attached to the workpiece-side surface of the screw head 18 and are illustrated in FIG. 2.

In the present case the screw is screwed in by means of a lock nut 28 and a washer 30. In the embodiment illustrated here the washer 30 is also provided with stampings 36 which have a rim produced by the stamping process and projecting in the direction of the workpiece 12, and thereby also create a good, low-resistance contact between the washer and the external part 12 on this side.

Alternatively the washer 30 could have been omitted and the nut 28 could also have been provided with appropriate teeth, and in this way an electrical contact can be produced between the nut 28 and the external part 12 in spite of painting or coating of this part 12.

Thus according to the invention, it is possible to use the teeth 27 below the screw head 18 for the electrical connection between the screw 16 and the external part 12, and as an alternative or in addition to this a washer 30 with appropriate teeth or raised portions can be provided, or this washer 30 can be omitted and the nut 28 can be provided with appropriate teeth and screwed directly on the external part 12.

In most cases, however, it is sufficient according to the invention to produce the electrical connection between the screw and the external part 12 via the teeth 27 on the underside of the screw head 18.

If the regions of the part 12 which are penetrated by the screw 16 are thicker in other applications than shown here, the contact can also be produced exclusively via the bushing 34 as the bushing 34 extends through the appropriately widened hole 11 and the widened portion of the bushing 15 of the bore 14 and itself creates the contact to the two workpieces 10, 12.

FIG. 2 shows a special screw 16 according to the invention as used for the screw connection according to FIG. 1, viewed from the front, i.e. from the shank of the screw.

In this case, in a deviation from the usual rules of technical drawing and for better understanding of the different diameter ratios, the bead 32 and the external thread 24 of the screw shank 22 are shown “as transparent”, so that the position and extent of the bushing 34 in relation to the other parts is clearly recognised. The outer edge of the bead 32 is illustrated by means of a part-circle on the left-hand side. On the right-hand half, the base circle diameter of the shank 22 and the external diameter of the external thread 24 are shown, wherein the normal diameter of the shank 22 is shown by solid lines and the external diameter of the thread 24 is shown by dash-dot lines.

The radially extending ribs 27, which are attached to the workpiece-side surface of the screw head 18 and serve to improve the contact between the screw head 18 and the surface of the workpiece 12, are clearly discernible here. The ribs 27 do not run as far as the external edge of the screw head 18, but merge there into a circumferential ring 38 which serves to prevent the penetration of moisture and thus corrosion phenomena on the ribs 27.

The shape of the bushing 34 according to the invention is explained in greater detail in FIG. 3.

As can clearly be seen in FIG. 3, the bushing 34 consists of a continuous cohesive sheet metal strip which is corrugated so that it has three corrugation peaks 40 and three corrugation troughs 42 over a circumference. Thus, viewed in the passage direction of the screw, this produces the shape of an equilateral triangle with very rounded tips and with slightly concave side edges in the central region. For improved contact, the surface of the bushing 34 can be formed with a cross-knurl or transverse knurl or can be roughened, as represented here by the shading. This roughening does not have to be limited to the inside; the outside can also be roughened.

FIG. 4 again shows the co-operation of the screw shank 22 and bushing 34 viewed in the direction coaxial to the screw shank 22, wherein the corrugation peaks 40 and corrugation troughs 42 are clearly discernible.

The corresponding external enveloping circle of the bushing 34 is indicated by a dotted circular line.

FIG. 5 shows the bushing 34 from the side. It is clearly discernible here that the bushing 34 is provided in the region of the corrugation peaks 40 with small stamped-out claws 44. These serve to improve the electrical contact with the inner face of the widened portion 15 of the bore 14. Alternatively for this purpose, studs can be can be embossed or a cross-knurl or transverse knurl or a roughening of the surface can be provided.

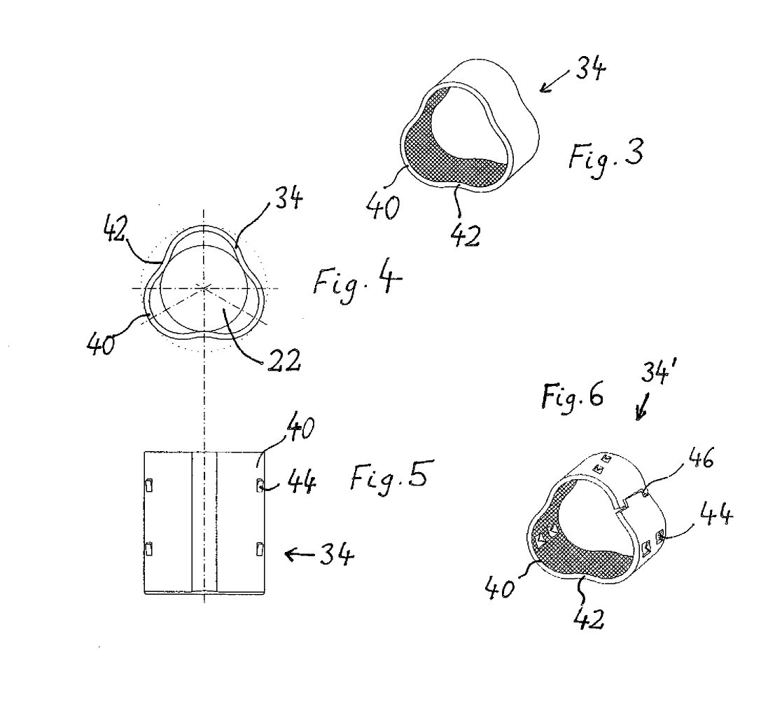

FIG. 6 shows a further bushing 34′ according to the invention which does not consist of a continuous sheet metal strip like the bushing 34 of FIG. 3, but is wound from a sheet metal strip. In this way, the production is simpler and more economical.

The ends of the sheet metal strip forming the bushing 34′ can either butt loosely in front of one another or, as shown here, they can be connected by a dovetail joint 46 or a simple guide. The embodiment by means of dovetailing or simple guiding has the advantage of greater stability.

Moreover this bushing 34′ also has three corrugation peaks 40 and three corrugation troughs 42 arranged alternately therewith, and is provided with stamped-out contact claws 44 in the region of the corrugation peaks 40.

Thus the present invention makes it possible for electrically conductive parts, preferably metal parts of a motor vehicle, to be already connected to earth so as to be electrically conductive with low resistance during installation of the connecting elements in order to comply with EMC requirements. According to the invention, this object is achieved in that the bushing 34 has contact on three flat strips with the screw 16 and the bushing 34 has, offset by 60° thereto, three further flat points of contact with the material in which the bushing is inserted. In contrast to the special screw according to German Utility Model 20 2010 007 769 U1, the bushing 34 according to the invention can compensate by its special, corrugated form for tolerances of the hole in which it is inserted. At the same time the inward curvature in the direction of the screw leads to the screw 16 always being clamped even when the bushing 34 is radially compressed from the outside. With other shapes the bushing would lift off from the screw due to the radial compression, and in this case according to the invention the pressure on the screw is even increased.

The bushing 34 itself can either be introduced into the element to be connected before the installation, and a quite standard screw (optionally comprising the special head 18 with the ribs 27) is used in the installation. Alternatively, as shown here, the bushing 34 can be pre-fixed on a special screw 16. For the insertion of the screw 16 and the bushing 34, the hole 11 in the workpiece 12 on which the head support is located must likewise be large enough for the bushing 34 to be passed through. Ideally for this purpose, the bushing 34 has a chamfer in order to avoid twisting. In this case the bead 32 on the special screw 16 is preferably provided with a chamfer having a diameter increasing towards the head 18 of the screw 16 in order quite reliably to avoid twisting of the bushing 34. The bead 32 must have a smaller diameter than the enveloping circle of the bushing 34 and the smallest diameter of the holes 11 and 15.

The bushing 34 itself may be designed to produce contact in a wide variety of ways. The contact can be made by small stamped-out claws 44 according to FIG. 5; alternatively, embossed studs, similar to the surface of a wood rasp, or a corrugated or roughened surface or a cross-knurl or transverse knurl can serve for this purpose. Since for the use of the bushing 34 according to the invention only the widening 15 of the bore 14 in the one workpiece 10 and, in some circumstances (depending upon the type of installation), an enlarged hole 11 in the other workpiece 12 have to be provided, this solution is also possible as a retrofit solution or a solution which can be implemented in the short term just before the start of series production.

The special design of the bushing 34 according to the invention always guarantees a secure seat for the screw 16, even when the bushing 34 is inserted into differently sized holes 15. Radial compression by the use in smaller holes does not lead to the screw 16 falling out but to an increasingly secure seat. The bushing 34 according to the invention can preferably be used as a retrofit solution. Other solutions, such as for example according to German Utility Model 20 2010 007 769, must always be taken into consideration at an early stage in the design, since the parts must be co-ordinated accordingly. By contrast, the bushing 34 according to the invention can be introduced simply at a later stage, in this case for example into a steering gear, by merely enlarging the through-hole there so that the bushing 34 fits therein. Then at most a suitable special screw with corresponding head geometry or a corresponding nut or washer would have to be used in order to produce the electrical contact with the other part 12. All other parts can remain unchanged.

The advantage of the present invention is that the earth connection between different automobile parts can be ensured without additional earth cables even if the corresponding parts are already painted, coated or provided with a passivation layer before the screw connection. In addition, the present invention has the advantage relative to the previously customary earth cable that high-frequency interference is also very effectively diverted. This is not necessarily offered with earth cables due to their unavoidable inductance.

On the other hand, according to the invention an appropriate contact between the screw 16 and the external part 12 is produced by the teeth 27 under the screw head 18 which cut through the paint layer on the external part 12. Alternatively or in addition, this can be effected by appropriate teeth or other projecting edges on a washer, wherein the washer can be arranged both under the screw head and also under a nut. Furthermore the nut can also be provided with corresponding teeth if no washers are used.

The screw head, the washer or the nut can be provided with an external circumferential ring in order to protect the screw connection, but in particular the points of contact with the destroyed paint coating on the external part 12, from the penetration of water and thus from corrosion.

In addition in the case of a connection by screw and nut on the workpiece-side surface of the nut, a toothing or other projections can also be provided. When a connection having a nut and washer is used, the washer may be appropriately provided with teeth or other projecting elements in order also to produce a good contact between the screw and the other part 12 also at the other end of the screw.

1. Electrically conductive screw connection between two parts (10, 12) which are screwed to one another by means of a screw (16), having a screw head (18) and a shank (22) with an external thread (24), and by means of a nut (28), wherein the screw (16) runs through a bore (14) in the one part (10), characterised in that the electrical contact between the other part (12) and the screw (16) is produced by teeth (27) on the workpiece-side surface of the screw head (18) and/or of the nut (28) or of a washer (30) arranged between the nut (28) and the other part (12), whereas the contact between the screw (16) and the one part (10) is produced by a bushing (34; 34′) which is formed so as to be radially elastic and which is arranged coaxially with respect to the shank (22) of the screw (16) in a portion (15) of the bore (14) having an enlarged internal diameter.

2. Electrically conductive screw connection according to claim 1, characterised in that the bushing (34; 34′) is formed from a corrugated sheet metal strip, of which the corrugations (40, 42) are arranged parallel to the axis of rotation of the bore (14).

3. Electrically conductive screw connection according to claim 2, characterised in that three corrugation peaks (40) and three corrugation troughs (42) are arranged over a circumference of the bushing (34; 34′).

4. Electrically conductive screw connection according to either claim 2 or claim 3, characterised in that the sheet metal strip from which the bushing (34) is formed is continuously closed.

5. Electrically conductive screw connection according to either claim 2 or claim 3, characterised in that the sheet metal strip from which the bushing (34′) is formed is wound and the ends butt loosely in front of one another.

6. Electrically conductive screw connection according to either claim 2 or claim 3, characterised in that the sheet metal strip from which the bushing (34′) is formed is wound and the ends are connected by means of dovetailing or simple guiding.

7. Electrically conductive screw connection according to claim 2, 3, 4, 5 or 6, characterised in that the bushing (34; 34′) is provided in the region of the corrugation peaks (40) with stamped contact claws (44) or with embossed studs or with a cross-knurl or transverse knurl.

8. Electrically conductive screw connection according to claim 2, 3, 4, 5 or 6, characterised in that the surface of the bushing (34; 34′) is at least partially corrugated or roughened.

9. Electrically conductive screw connection according to any of claims 1 to 8, characterised in that the portion (15) of the bore (14) having the enlarged internal diameter is arranged on the side of the one part (10) facing the screw head (18).

10. Electrically conductive screw connection according to claim 9, characterised in that the other part (12) has a hole (11) for the passage of the screw (16) of which the internal diameter is greater than the external diameter of the bushing (34; 34′).

11. Electrically conductive screw connection according to claim 9, characterised in that the bushing (34; 34′) is attached directly below the screw head so as to be rotatable but non-detachable on the shank (22) of the screw (16).

12. Electrically conductive screw connection according to claim 11, characterised in that, for installation of the bushing (34; 34′), the shank (22) of the screw (16) is provided above the external thread (24) with a radial circumferential bead (32), of which the external diameter is less is than the enveloping circle of the bushing (34; 34′).

13. Electrically conductive screw connection according to claim 12, characterised in that the circumferential bead (32) is chamfered towards the external thread (24) of the screw (16) so that the bead (32) merges into the external thread (24) as the height decreases.

14. Special bushing for low-resistance connection of a screw (16) to a workpiece (10) into which the screw (16) is inserted, characterised in that the bushing (34; 34′) is formed from a corrugated sheet metal strip of which the corrugations (40, 42) are arranged parallel to the axis of rotation of the bushing (34).

15. Special bushing according to claim 14, characterised in that three corrugation peaks (40) and three corrugation troughs (42) are arranged over a circumference of the bushing (34; 34′).

16. Special bushing according to either claim 14 or claim 15, characterised in that the sheet metal strip from which the bushing (34) is formed is continuously closed.

17. Special bushing according to either claim 14 or claim 15, characterised in that the sheet metal strip from which the bushing (34′) is formed is wound and the ends butt loosely in front of one another.

18. Special bushing according to either claim 14 or claim 15, characterised in that the sheet metal strip from which the bushing (34′) is formed is wound and the ends are connected by means of dovetailing or simple guiding.

19. Special bushing according to claim 14, 15, 16, 17 or 18, characterised in that the bushing (34; 34′) is provided in the region of the corrugation peaks (40) with stamped contact claws (44) or with embossed studs or with a cross-knurl or transverse knurl.

20. Special bushing according to claim 14, 15, 16, 17 or 18, characterised in that the outer surface of the bushing (34; 34′) is at least partially corrugated or roughened.
